(19) United States
(12) Patent Application Publication
(10) Pub. No.: US 2012/0133610 A1
(43) Pub. Date: May 31, 2012

(54) METHOD FOR ADJUSTING REGION OF INTEREST AND RELATED OPTICAL TOUCH MODULE

(76) Inventor: Yu-Yen Chen, New Taipei City (TW)

(21) Appl. No.: 13/049,849

(22) Filed: Mar. 16, 2011

(30) Foreign Application Priority Data
Nov. 26, 2010 (TW) 099140970

(51) Int. Cl. G06F 3/045; G06K 9/48

(52) U.S. Cl. 345/174; 382/199

(57) ABSTRACT

A method for adjusting region of interest is applied to positioning on a touch surface of a screen. The method includes capturing at least one region image toward the touch surface, setting a predetermined region of interest on the region image, performing an edge identification process on the predetermined region of interest to generate an actual region of interest, and recording the actual region of interest.

### BACKGROUND OF THE INVENTION

1. Field of the Invention

The invention relates to an adjusting method and a related optical touch module, and more specifically, to a method for adjusting region of interest and a related optical touch module.

2. Description of the Prior Art

For a conventional optical touch module, positioning of a touch object on a touch surface of a touch screen is achieved by position comparison of the touch object and a side frame of the touch screen. The calculating efficiency of the optical touch module in touch positioning is determined by whether a contour of a region of interest for the touch object is consistent with a contour of the side frame of the touch screen. A well-chosen region of interest makes information calculation of the optical touch module more efficient to reduce the related calculating time, so that the calculating efficiency of the optical touch module in touch positioning can be enhanced greatly.

In general, since a predetermined region of interest needs to be set manually and the optical imaging condition of every predetermined region of interest is different from each other, every optical touch module needs to set its predetermined region of interest in advance before leaving the factory. However, the said setting is time-consuming and strenuous because variation of optical imaging is nonlinear. Furthermore, after the optical touch module is used over a period of time, unsuitability or offset of the predetermined region of interest may occur due to some factor (e.g. the optical touch module receiving sudden impact), so as to reduce positioning accuracy or touch sensitivity of the optical touch module. As a result, it is usually required to correct the predetermined region of interest for solving the said problem, so as to cause the optical touch module much inconvenience in practical application.

### SUMMARY OF THE INVENTION

An embodiment of the invention provides a method for adjusting region of interest to be applied to positioning on a touch surface of a screen. The method includes capturing at least one region image toward the touch surface, setting a predetermined region of interest on the region image, performing an edge identification process on the predetermined region of interest to generate an actual region of interest, and recording the actual region of interest.

An embodiment of the invention further provides an optical touch module capable of adjusting region of interest. The optical touch module includes a screen, at least one image capturing device, and an image processing device. The screen has a touch surface. The image capturing device is disposed on the screen for capturing a region image toward the touch surface. The image processing device is disposed in the screen and electrically connected to the image capturing device. The image processing device includes a processing unit, an edge identification unit, and a recording unit. The processing unit is used for setting a predetermined region of interest on the region image. The edge identification unit is used for performing an edge identification process on the predetermined region of interest to generate an actual region of interest. The recording unit is used for recording the actual region of interest.

These and other objectives of the invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an optical touch module according to an embodiment of the invention.

FIG. 2 is a functional block diagram of an image processing device in FIG. 1.

FIG. 3 is a flowchart of a method for utilizing the optical touch module in FIG. 1 to perform region-of-interest adjustment.

### DETAILED DESCRIPTION

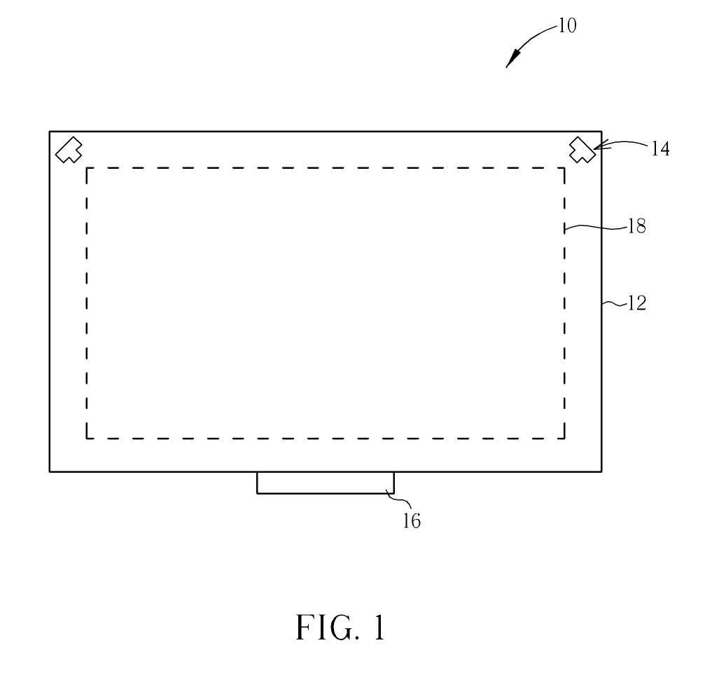

Please refer to FIG. 1, which is a diagram of an optical touch module 10 according to an embodiment of the invention. As shown in FIG. 1, the optical touch module 10 includes a screen 12, at least one image capturing device 14 (two shown in FIG. 1), and an image processing device 16. The screen 12 has a touch surface 18 for a user to perform touch operations. In this embodiment, the image capturing devices 14 are respectively disposed at the upper-left and upper-right corners of the screen 12 and face the touch surface 18. In such a manner, the image capturing devices 14 can capture corresponding region images for optical touch positioning of an object (e.g. a stylus, a user's finger, etc.) on the touch surface 18. The image capturing device 14 is preferably a camera.

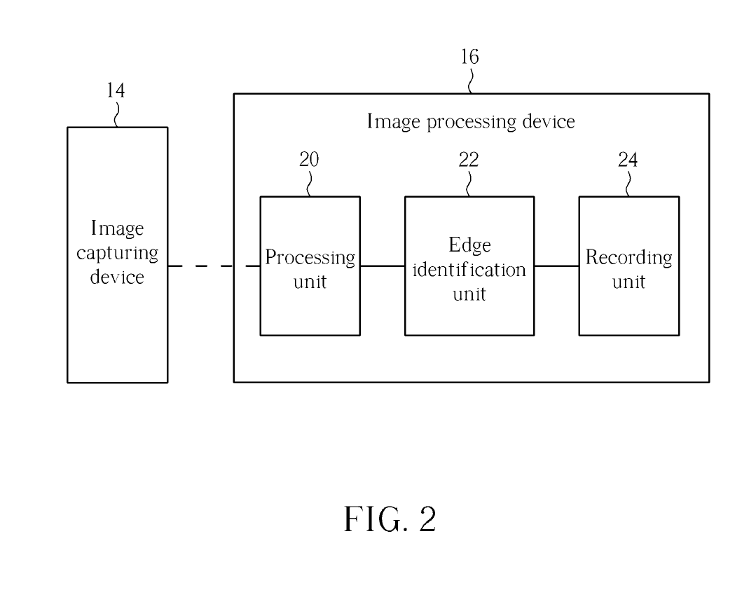

Please refer to FIG. 2, which is a functional block diagram of the image processing device 16 in FIG. 1. The image processing device 16 is disposed on the screen 12 and electrically connected to the image capturing device 14. As shown in FIG. 2, the image processing device 16 includes a processing unit 20, an edge identification unit 22, and a recording unit 24. The processing unit 16 is preferably a hardware, a software, or a firmware for performing related image processing. The processing unit 20 is used for setting a predetermined region of interest on a region image captured by the image capturing device 14, and performing optical touch positioning of the touch object according to an actual region of interest identified by the edge identification unit 22. The edge identification unit 22 is used for performing an edge identification process on the predetermined region of interest. The recording unit 24 is used to record the actual region of interest as a reference for the following region-of-interest adjustment or optical touch positioning.

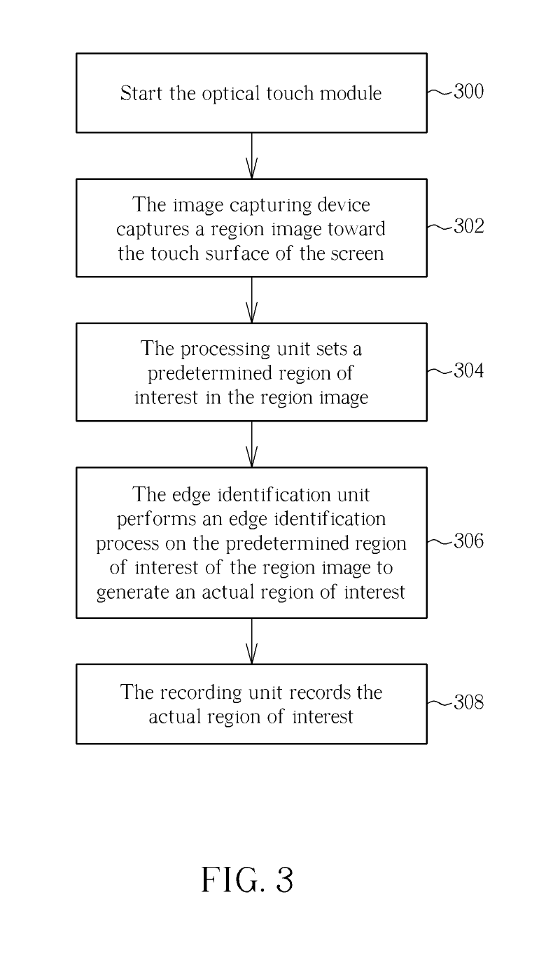

Next, please refer to FIG. 1, FIG. 2, and FIG. 3. FIG. 3 is a flowchart of a method for utilizing the optical touch module 10 in FIG. 1 to perform region-of-interest adjustment. The method includes the following steps.

Step 300: Start the optical touch module 10;

Step 302: The image capturing device 14 captures a region image toward the touch surface 18 of the screen 12;

Step 304: The processing unit 20 sets a predetermined region of interest in the region image;

Step 306: The edge identification unit 22 performs an edge identification process on the predetermined region of interest of the region image to generate an actual region of interest;

Step 308: The recording unit 24 records the actual region of interest.

More detailed description for the said steps is provided as follows in view of image processing between the image capturing device 14 disposed at the upper-right corner of the screen 12 and the processing unit 16. As for the related description for image processing between the image capturing device 14 disposed at the upper-left corner of the screen 12 and the processing unit 16, it can be reasoned by analogy and therefore be omitted herein. When a user wants to operate the optical touch module 10, the user needs to start the optical touch module 10 first (Step 300). At this time, the image capturing device 14 captures the corresponding region image toward the touch surface 18 of the screen 12 (Step 302). The said region image is an image captured from a view angle of the upper-right corner of the screen 12 as shown in FIG. 1, including a side-frame image of the screen 12. Subsequently, in Step 304, the processing unit 20 sets the predetermined region of interest in the region image captured by the image capturing device 14. The said predetermined region of interest is an estimative region covering the side-frame image of the screen 12.

After setting the predetermined region of interest in the region image, the edge identification unit 22 performs the edge identification process in the predetermined region of interest (Step 306), so as to capture an actual edge of the side-frame image of the screen 12 (i.e. the actual region of interest mentioned in Step 306). It should be mentioned that the edge identification process adopted in Step 306 is commonly seen in the prior art. In this embodiment, the edge identification unit 22 can, but not limited thereto, perform an edge detection process, an edge thinning process, and a line fitting process sequentially to generate the actual region of interest. The edge identification unit 22 may also utilize other edge identification process instead. Furthermore, the edge identification unit 22 may only perform the said edge detection process or omit the said line fitting process for simplifying the edge identification process of the optical touch module 10. As for the related description for the edge detection process, the edge thinning process and the line fitting process, it is omitted herein since they are conventional image processing methods.

Finally, after performing the said steps sequentially, the image processing unit 16 utilizes the recording unit 24 to record the actual region of interest (Step 308). The recording unit 24 is preferably a memory unit for data storage. It should be noted that the actual region of interest generated via the said steps is usually a crooked strip-shaped region due to nonlinear variation of optical imaging. Thus, for enhancing the calculating efficiency of the following image processing and touch positioning according to the actual region of interest, the processing unit 20 can perform a normalization process on the actual region of interest first, so that the actual region of interest can be transformed into a rectangular region of interest and then be stored in the recording unit 24. Instead, the recording unit 24 may also record the actual region of interest in a crooked shape without performing the said normalization process. As for which method is utilized, it depends on the practical application of the optical touch module 10.

The actual region of interest stored in the recording unit 24 can be applied to the following image processing of the optical touch module 10. For example, for region-of-interest adjustment, optimal region-of-interest adjustment for the optical touch module 10 can be achieved by automatically performing the said steps when starting the optical touch module 10 every time. Thus, even if unsuitability or offset of the predetermined region of interest occurs due to some factor (e.g. the optical touch module 10 receiving sudden impact) after the optical touch module 10 is used over a period of time, the optical touch module 10 can still generate a corresponding actual region of interest, that is consistent precisely with the side-frame image of the screen 12, to replace the predetermined region of interest. As a result, the said problem can be solved accordingly to enhance the calculating efficiency of the optical touch module 10 in image processing.

Furthermore, if the image capturing device 14 utilizes a periscopic lens to capture the region image, crooked image deformation may occur at an edge of the side-frame image of the screen 12 to cause the edge to fall off the predetermined region of interest. Thus, use of the periscopic lens may cause incorrect calculation in the following image processing of the optical touch module 10. At this time, if the predetermined region of interest is replaced by the actual region of interest stored in the recording unit 24 instead, incorrect calculation, which is caused by inconsistence between the edge of the side-frame image and the predetermined region of interest, can be avoided accordingly since the contour of the actual region of interest can be precisely consistent with the contour of the side frame of the screen 12. As a result, accuracy of the optical touch module 10 in edge touch positioning can be further improved.

For optical touch positioning, according to the said actual region of interest and trigonometric functions, planar positioning of a touch object on the touch surface 18 can be performed more accurately since the contour of the actual region of interest can be precisely consistent with the contour of the side frame of the screen 12 in the region image. Furthermore, the aforementioned method for generating an actual region of interest is not limited to an optical touch module with an image-capturing design. That is, the method can also be applied to an optical touch module capable of performing planar positioning of a touch object by utilizing position comparison of the touch object and a region of interest, such as a photosensitive touch module.

Compared with the prior art, the invention utilizes an edge identification process to generate an actual region of interest in a predetermined region of interest. Since a contour of the actual region of interest is consistent with a contour of a side frame of a screen more precisely, an optical touch module of the invention can not only increase its calculating efficiency in image processing after performing the aforementioned region-of-interest adjustment, but also solve the problem that a region of interest needs to be set manually. Furthermore, optical touch positioning for a touch object can be performed more accurately based on the actual region of interest.

Those skilled in the art will readily observe that numerous modifications and alterations of the device and method may be made while retaining the teachings of the invention.

What is claimed is:

1. A method for adjusting region of interest to be applied to positioning on a touch surface of a screen, the method comprising:
capturing at least one region image toward the touch surface;
setting a predetermined region of interest on the region image;
performing an edge identification process on the predetermined region of interest to generate an actual region of interest; and
recording the actual region of interest.

2. The method of claim 1, wherein performing the edge identification process on the predetermined region of interest to generate the actual region of interest comprises:
performing an edge detection process on the predetermined region of interest to generate the actual region of interest.

3. The method of claim 2, wherein performing the edge identification process on the predetermined region of interest to generate the actual region of interest comprises:
performing an edge thinning process on the predetermined region of interest after performing the edge detection process to generate the actual region of interest.

4. The method of claim 3, wherein performing the edge identification process on the predetermined region of interest to generate the actual region of interest comprises:
performing a line fitting process on the predetermined region of interest after performing the edge thinning process to generate the actual region of interest.

5. The method of claim 1, wherein recording the actual region of interest comprises:
performing a normalization process on the actual region of interest to generate a rectangular region of interest; and
recording the rectangular region of interest.

6. The method of claim 1 further comprising:
performing optical touch positioning of an touch object on the touch surface of the screen according to the actual region of interest.

7. An optical touch module capable of adjusting region of interest, the optical touch module comprising:
a screen having a touch surface;
at least one image capturing device disposed on the screen for capturing a region image toward the touch surface; and
an image processing device disposed in the screen and electrically connected to the image capturing device, the image processing device comprising:
a processing unit for setting a predetermined region of interest on the region image;
an edge identification unit for performing an edge identification process on the predetermined region of interest to generate an actual region of interest; and
a recording unit for recording the actual region of interest.

8. The optical touch module of claim 7, wherein the edge identification unit is used for performing an edge detection process on the predetermined region of interest to generate the actual region of interest.

9. The optical touch module of claim 8, wherein the edge identification unit is used for performing an edge thinning process on the predetermined region of interest after performing the edge detection process to generate the actual region of interest.

10. The optical touch module of claim 9, wherein the edge identification unit is used for performing a line fitting process on the predetermined region of interest after performing the edge thinning process to generate the actual region of interest.

11. The optical touch module of claim 7, wherein the processing unit is further used for performing a normalization process on the actual region of interest to generate a rectangular region of interest, and the recording unit is used for recording the rectangular region of interest.

12. The optical touch module of claim 7, wherein the processing unit is further used for performing optical touch positioning of a touch object on the touch surface of the screen according to the actual region of interest.

13. The optical touch module of claim 7, wherein the image capturing device is a camera.
